(19) United States
(12) Patent Application Publication
(10) Pub. No.: US 2010/0315472 A1
(43) Pub. Date: Dec. 16, 2010

(54) PERFORATED AND/OR POINTED SEALING FILM FOR EASY PEEL INKJET PRINTHEAD AND INK TANK SYSTEM APPLICATIONS

(76) Inventors: JAMES DANIEL ANDERSON, JR., Harrodsburg, KY (US); Richard Earl Corley, JR., Richmond, KY (US); Kin Ming Kwan, Lexington, KY (US); Bhaskar Ramakrishnan, Lexington, KY (US); William Bruce Rose, Lexington, KY (US)

Correspondence Address: LEXMARK INTERNATIONAL, INC.;INTELLECTUAL PROPERTY LAW DEPARTMENT, 740 WEST NEW CIRCLE ROAD, BLDG. 082-1, LEXINGTON, KY, 40550-0999, US

(21) Appl. No.: 12/785,871

(22) Filed: May 24, 2010

Related U.S. Application Data
(63) Continuation of application No. 11/406,627, filed on Apr. 19, 2006, now abandoned.

(51) Int. Cl. B41J 2/175

(52) U.S. Cl. 347/86

(57) ABSTRACT

A method of packaging an ink tank for shipment, the method comprising: (a) sealing a first substratum to an ink tank to inhibit fluid communication between an interior of the ink tank and an external environment by way of an ink outlet port of the ink tank, the resultant seal between the first substratum and the ink tank includes at least one of an apex at least partially defined by two substantially linear segments being angled from one another between about 20 degrees to about 160 degrees and fractions separating portions of the substrate from one another; and (b) sealing a second substratum to the ink tank to inhibit fluid communication between the interior of the ink tank and the external environment by way of an ink vent of the ink tank, where the first substratum and the second substratum are removable from the ink tank.

This application claims priority and benefit as a continuation application of U.S. patent application Ser. No. 11/406,627, filed Apr. 19, 2006.

### RELATED ART

The present invention is directed to sealed fluid containers and, more specifically, to sealed ink containers and methods of sealing and discontinuing the seal of such containers.

### SUMMARY

The present invention is directed to sealed fluid containers and, more specifically, to sealed ink containers and methods of sealing and discontinuing the seal of such containers. The invention addresses devices and methods to selectively inhibit fluid leakage from an ink container by using removable substrates. In one exemplary embodiment, the invention includes mounting a removable temporary substrate, such as a polymer film, to an ink tank to inhibit ink from exiting from the container. The temporary substrate is removed from the outlet nozzle or orifice prior to installation of the ink tank and, therefore, methods of removing the substrate are also addressed. In exemplary form, the temporary substrate may include perforations that provide a line (or lines) of demarcation along which the substrate will tear to facilitate removal of the substrate, without necessarily requiring complete removal of the substrate. An alternate exemplary embodiment, includes non-circular shaped seals (the ‘seal’ is the area between the substrate and the mouth of the outlet nozzle or orifice in which the substrate is bonded to the mouth of the substrate prior to the tearing/pulling of the substrate from the nozzle or orifice) that concentrate the pulling forces a user may exert to bring about a calculated separation between the ink tank and the substrate and reduce the force necessary to remove the substrate. A further exemplary embodiment includes a teardrop-shaped seal that includes a point at one end substantially facing in the direction of the pull-tab that acts to concentrate the pulling forces to bring about removal of the substrate in a consumer-friendly fashion. Other pointed shapes (having one or more points, where at least one of the points faces substantially in the direction of the pull tab) for the seal are within the scope of the invention. The following is an exemplary listing of embodiment within the scope of the present invention, however, reference is had to the Detailed Description for a more thorough understanding of the invention.

Some embodiments of the present invention provide a method of sealing an ink tank, the method comprising mounting a removable substrate to an ink tank over an ink outlet to inhibit fluid travel beyond the ink outlet, the removable substrate being mounted to the ink tank to form a non-circular seal between the substrate and the ink tank, the shape of the seal including an apex for concentrating a pulling force applied to the removable substrate when the substrate is removed from the ink tank to allow fluid travel beyond the ink outlet, the removable substrate including at least one of a polymer film, a metallic film, a metallized film, and a composite film.

In a more detailed embodiment, the ink tank includes an outlet conduit extending from a wall of the ink tank, the outlet conduit terminating at a mouth, the removable substrate is mounted over the mouth, and the mouth includes a teardrop-shaped outline. In yet another more detailed embodiment, the teardrop-shaped outline includes the apex that has an angle between 25 degrees and 160 degrees, and the internal shape of the outlet conduit has a circular cross-section. In a further detailed embodiment, the teardrop-shaped outline includes the apex that is angled between 60 and 120 degrees, and the mouth includes an exposed top surface to which the removable substrate is mounted to form a teardrop-shaped seal between the removable substrate and the outlet conduit. In still a further detailed embodiment, the removable substrate includes a polymer film, and the act of mounting the removable substrate to the mouth of the outlet conduit includes utilizing at least one of adhesive sealing, laser welding, ultrasonic welding, vibrational welding, heat staking, and induction welding to form the non-circular seal. In a more detailed embodiment, the removable substrate includes a polymer film, and the act of mounting the removable substrate to the ink tank includes utilizing at least one of adhesive sealing, laser welding, ultrasonic welding, vibrational welding, heat staking, and induction welding to form the non-circular seal. In a more detailed embodiment, the ink outlet includes a circular internal cross-section, and the act of mounting the removable substrate to the ink tank includes utilizing at least one of adhesive sealing, laser welding, ultrasonic welding, vibrational welding, heat staking, and induction welding to form the non-circular seal.

Some embodiments of the present invention provide a method of sealing an ink tank, the method comprising mounting a substrate to an ink tank to inhibit fluid flow through an ink outlet of the ink tank, the substrate including perforations defining distinct division points along which a portion of the substrate will separate from a remainder of the substrate upon application of a predetermined applied force to facilitate removal of at least the portion of the substrate.

In a more detailed embodiment, the substrate is comprised of multiple plies, and the perforations are oriented in a semi-circular arrangement through at least one ply of the multiple plies. In yet another more detailed embodiment, the perforations of the substrate at least partially outline and encompass the ink outlet, and removal of the portion of the substrate upon application of a predetermined applied force results in a segment of the substrate remaining mounted to the ink tank. In a further detailed embodiment, the substrate is comprised of multiple plies, and the perforations comprise angular shapes through at least one ply of the multiple plies. In still a further detailed embodiment, the act of mounting the substrate to the ink tank includes forming a seal between the substrate and the ink tank, and the perforations are adjacent to the seal between the substrate and the ink tank so that upon application of the predetermined applied force the substrate is completely removed from the ink tank. In a more detailed embodiment, the act of mounting the substrate to the ink outlet includes utilizing at least one of adhesive sealing, laser welding, ultrasonic welding, vibrational welding, heat staking, and induction welding. In a more detailed embodiment, the ink tank includes a projection having a teardrop-shaped outline that contacts the first substrate, the act of mounting the substrate to the ink tank includes mounting the substrate to the projection to form a seal between the substrate and projection, and the perforations are backset from the ink outlet.

Some embodiments of the present invention provide a method of fabricating a shipping unit of an inkjet cartridge, the method comprising (a) fabricating an ink tank; (b) fabricating a shipping clip that includes a recess for receiving at least a portion of the ink tank; (c) mounting a film to the shipping clip; and (d) mounting the film to the ink tank to seal an outlet orifice of the ink tank in order to inhibit fluid flow through the outlet orifice.

In a more detailed embodiment, the ink tank includes an outlet projection having a non-circular outline, and the act of mounting the film to the ink tank includes mounting the film to the outlet projection. In yet another more detailed embodiment, the ink tank includes an outlet projection, the act of mounting the film to the ink tank includes mounting the film to the outlet projection, and the film includes perforations defining distinct division points along which a portion of the film will separate from a remainder of the film. In a further detailed embodiment, the method further comprises mounting a sealing label to the ink tank and to the shipping clip, where the act of mounting the sealing label to the ink tank and to the shipping clip includes utilizing at least one of adhesive sealing, laser welding, ultrasonic welding, vibrational welding, heat staking, and induction welding. In still a further detailed embodiment, the act of mounting the sealing label to the ink tank and to the shipping clip includes utilizing heat staking to liquefy a portion of the shipping clip to mount the label to the shipping clip. In a more detailed embodiment, the label includes orifices, the shipping clip includes upstanding features that are encircled by the orifices of the label, and the act of heat staking includes liquefying the upstanding features to at least partially encapsulate the label.

Some embodiments of the present invention provide a method of packaging an ink tank for shipment, the method comprising: (a) sealing a first substratum to an ink tank to inhibit fluid communication between an interior of the ink tank and an external environment by way of an ink outlet port of the ink tank, the resultant seal between the first substratum and the ink tank includes at least one of an apex at least partially defined by two substantially linear segments being angled from one another between about 20 degrees to about 160 degrees and fractions separating portions of the substrate from one another; and (b) sealing a second substratum to the ink tank to inhibit fluid communication between the interior of the ink tank and the external environment by way of an ink vent of the ink tank, where the first substratum and the second substratum are removable from the ink tank.

In a more detailed embodiment, the method further comprises mounting a shipping clip to the ink tank, where the shipping clip is mounted to the first substratum. In yet another more detailed embodiment, the method further comprises mounting a shipping clip to the ink tank, where the shipping clip is mounted to the second substratum.

Some embodiments of the present invention provide a method of packaging an ink tank for shipment, the method comprising: (a) sealing a first substratum to an ink tank to inhibit fluid communication between an interior of the ink tank and an external environment by way of an ink outlet port of the ink tank, the resultant seal between the first substratum and the ink tank includes at least one of an apex at least partially defined by two substantially linear segments being angled from one another between about 20 degrees to about 160 degrees and fractions separating portions of the substrate from one another; and (b) sealing a second substratum to the ink tank to inhibit fluid communication between the interior of the ink tank and the external environment by way of an ink vent of the ink tank, where the first substratum and the second substratum are removable from the ink tank.

In a more detailed embodiment, the method further comprises mounting a shipping clip to the ink tank, where the shipping clip is mounted to the first substratum. In yet another more detailed embodiment, the method further comprises mounting a shipping clip to the ink tank, where the shipping clip is mounted to the second substratum.

Some embodiments of the present invention provide an ink tank comprising a container body housing ink therein, the container body having a flexible substrate mounted thereto to form a seal that substantially inhibits ink from leaking through an outlet port of the container body, the seal outlining a non-circular shape that includes an apex for concentrating a pulling force applied to the flexible substrate to facilitate removal of the flexible substrate from the ink tank to allow ink to egress from the outlet port.

In a more detailed embodiment, the flexible substrate includes at least one of a polymer film, a metallic film, and a composite film. In yet another more detailed embodiment, the apex is at least partially defined by two substantially linear segments angled with respect to one another between about 20 degrees to about 160 degrees. In still another more detailed embodiment, the outlet port is at least partially defined by a projection that extends from the container body, and the projection outline includes a teardrop-shaped cross-section. In a further detailed embodiment, the ink tank includes a shipping clip receiving at least a portion of the container body, the shipping clip concurrently mounted to the container body and the flexible substrate, the flexible substrate is permanently mounted to the shipping clip, and the flexible substrate is temporarily mounted to the container body.

Some embodiments of the present invention provide an ink tank comprising a container body housing ink therein, the container body having a removable substrate mounted thereto to form a seal that substantially inhibits ink from leaking through an outlet port of the container body, the flexible substrate including a plurality of fractures to facilitate separation of portions of the substrate from one another, the plurality of fractures outlining the outlet port of the container body.

In a more detailed embodiment, the removable substrate includes at least one of a polymer film, a metallic film, and a composite film. In yet another more detailed embodiment, the outlet port is at least partially defined by a projection that extends from the container body, the removable substrate is mounted to the projection, and the fractures at least partially circumscribe the outlet port. In still another more detailed embodiment, the removable substrate, includes multiple plies, and the fractures are oriented within the removable substrate so as to allow an entire portion of the removable substrate to be removed along the fractures. In a further detailed embodiment, the fractures of the removable substrate are adjacent to the seal.

Some embodiments of the present invention provide an ink tank comprising: (a) a container body housing ink therein, the container body including retention arms and an outlet port through which ink egresses; and, (b) a repositionable cap comprising a sealing substrate mounted to a platform that includes ramps to interact with the retention arms of the container body to releasably mount the repositionable cap to the container body to form a fluid tight seal between the container body and the sealing substrate to inhibit ink from passing through the outlet port.

### BRIEF DESCRIPTION OF THE DRAWINGS

FIG. 1 is a profile cut-away view of a first exemplary embodiment of the present invention;

FIG. 2 is an enlarged profile cut-away view of a portion of FIG. 1;

FIG. 3 is a bottom view of a first exemplary ink tank in accordance with the present invention;

FIG. 4 is a bottom view of a first exemplary ink tank in accordance with the present invention;

FIG. 5 is a pictorial representation of an adhesive failure mode;

FIG. 6 is a pictorial representation of a cohesive failure mode;

FIG. 7 is a pictorial representation of a sealant delamination failure mode;

FIG. 8 is a pictorial representation of an interfacial failure mode;

FIG. 9 is an exemplary complementary plot of load versus crosshead;

FIG. 10 is an exemplary representative view of an exemplary snout from which the data plot of FIG. 9 was generated;

FIG. 11 is a profile view of an exemplary shipping unit in accordance with the present invention;

FIG. 12 is an overhead view of the exemplary shipping unit of FIG. 11;

FIG. 13 is a cut-away, profile view of an exemplary shipping clip;

FIG. 14 is a cut-away, profile view of an exemplary shipping clip having a film mounted thereto;

FIG. 15 is a cut-away, profile view of an exemplary shipping clip having a film and an ink tank mounted thereto;

FIG. 16 is a cut-away, profile view of an exemplary shipping clip having a film, an ink tank, and a label mounted thereto;

FIG. 17 is a frontal view of a top portion of the exemplary shipping clip and label before a thermal sealing operation;

FIG. 18 is a frontal view of a top portion of the exemplary shipping clip and label of FIG. 17 subsequent to the thermal sealing operation;

FIG. 19 is an overhead view of a second exemplary shipping unit;

FIG. 20 is a frontal view of a top portion of the exemplary shipping unit of FIG. 19 before a thermal sealing operation;

FIG. 21 is a frontal view of a top portion of the exemplary shipping unit of FIG. 20 subsequent to the thermal sealing operation;

FIG. 22 is an overhead view of a second alternate exemplary shipping unit;

FIG. 23 is a frontal view of the second alternate exemplary shipping unit of FIG. 22 with the label retainer in the open position;

FIG. 24 is a frontal view of the second alternate exemplary shipping unit of FIG. 22 with the label retainer in the closed position;

FIG. 25 is an overhead and profile view of an exemplary snout in accordance with the present invention;

FIG. 26 is an overhead and profile view of an exemplary sealing film in accordance with the present invention;

FIG. 27 is an overhead and profile view of the exemplary sealing film of FIG. 26 being mounted to the snout of FIG. 25 in accordance with the present invention;

FIG. 28 is an overhead and profile view of a further exemplary snout in accordance with the present invention;

FIG. 29 is an overhead view of a further exemplary sealing film in accordance with the present invention;

FIG. 30 is an overhead view of the exemplary sealing film of FIG. 29 being mounted to the exemplary snout of FIG. 28 in accordance with the present invention;

FIG. 31 is an overhead view of the exemplary sealing film of FIG. 29 being removed from the exemplary snout of FIG. 28 in accordance with the present invention;

FIG. 32 is an overhead view of the exemplary sealing film of FIG. 29 being removed from the exemplary snout of FIG. 28 having a gasket installed in contact with the exemplary snout;

FIG. 33 is an overhead and profile view of a further exemplary ink tank in accordance with the present invention;

FIG. 34 is a profile view of an exemplary shipping clip in accordance with the present invention;

FIG. 35 is a magnified view of the exemplary attachment arms of the ink tank of FIG. 33;

FIG. 36 is a magnified view showing the interaction between the exemplary attachment arms of FIG. 35 and the shipping clip of FIG. 34.

FIG. 37 is a bottom view of the exemplary shipping clip of FIG. 34; and

FIG. 38 is a profile view of the exemplary ink tank of FIG. 33 with the shipping clip of FIG. 34 installed.

### DETAILED DESCRIPTION

The exemplary embodiments of the present invention are described and illustrated below to encompass methods of printing images onto a substrate as well as goods having images printed thereon. Of course, it will be apparent to those of ordinary skill in the art that the preferred embodiments discussed below are exemplary in nature and may be reconfigured without departing from the scope and spirit of the present invention. However, for clarity and precision, the exemplary embodiments as discussed below may include optional steps, methods, and features that one of ordinary skill should recognize as not being a requisite to fall within the scope of the present invention. For the purposes of the present application, the term “ink tank” shall include any type of ink tank, cartridge or reservoir component or system for use with an ink-based printer.

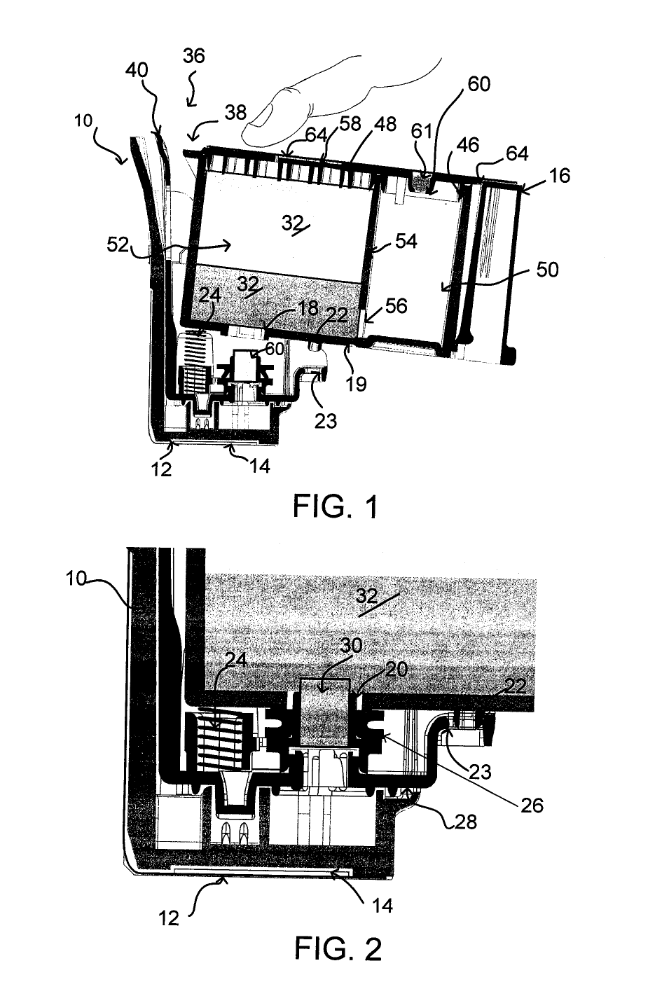

Referencing FIGS. 1 and 2, an exemplary inkjet printhead body 10 includes a printhead 12 having a plurality of inkjet nozzles 14 through which ink is ejected onto a medium (not shown) to form an image onto the medium. An ink cartridge 16 is adapted to be received by the inkjet body 10 so that a snout 18 extending from the floor 19 of the ink cartridge 16 circumscribes a receiving port 20 of the inkjet body 10 to deliver ink from the ink cartridge 16 to the printhead 12. Proper alignment of the snout 18 with respect to the receiving port 20 also corresponds to alignment between a projection 22 extending from the floor 19 of the ink cartridge 16 and a complementary recess 23 of the inkjet body 10.

Downward movement of the ink cartridge 16, when the snout 18 and projection 22 are respectively in alignment with the receiving port 20 and the recess 23, compresses a spring 24 of the inkjet body 10 and causes the snout 18 to engage a gasket 26 circumscribing the cylindrical receiving port 20. Further downward movement of the ink cartridge 16 further compresses the gasket 26 to create a fluidic seal between the snout 18 and a horizontal platform 28 extending from the receiving port 20. This fluidic seal ensures that communication between a wicking material 30 within the receiving port 20 and a backpressure medium 32 within a backpressure chamber 34 of the ink cartridge 16 is operative to transfer ink from within the ink cartridge 16 to the printhead 12 without substantial vapor loss therebetween.

A snap-fit latch 36 is formed by the interaction between a catch 38 of the ink cartridge 16 and a repositionable lever 40 of the inkjet body 10 to secure the ink cartridge 16 in a retained position with respect to the inkjet body 10 (see FIG. 2). Movement of the lever 40 out of engagement with the catch 38 is operative to vertically displace the ink cartridge 16 from the inkjet body 10 using the stored force of the previously compressed spring 24 (see FIG. 1).

The exemplary inkjet printhead 12 of this embodiment is separate from the ink cartridge 16 supplying ink to the nozzles 14. This configuration dictates using the same or a different printhead 12 with differing ink cartridges 16. The principal advantage associated with a reusable printhead configuration is a cost savings by not having to fabricate a new printhead 12 each time the ink cartridge 16 has been expended. In this exemplary embodiment, the inkjet body 10 and ink cartridge 16 are utilized with an on-carrier printer (not shown) that includes a carriage across which the inkjet body 10 and ink cartridge 16 traverse to deposit droplets of ink onto a print medium to form the desired image. It is to be understood, however, that the exemplary embodiments of the instant invention are also applicable with off-carrier reservoirs that are remote from the printhead body 10 and remain stationary as the printhead body 10 traverses horizontally across the carriage, or in those instances where the printhead 12 remains stationary and the print medium is repositioned.

Referring to FIG. 1, an exemplary replacement ink cartridge 16 in accordance with the instant invention includes a hollowed-out body 46 that receives a lid 48 to define an ink reservoir system that includes a free ink chamber 50 and a felt chamber 52. A partition wall 54 within the ink cartridge 16 substantially divides the chambers 50, 52 from one another, however, a passage 56 within a lower portion of the partition wall 54 allows fluid communication between the chambers 50, 52.

An air vent 58 is provided through the lid 48 to allow fluid communication between the felt chamber 52 and the external environment. The vent 58 is particularly helpful in accommodating the expansion and compression of gases within the felt chamber 52 that occur as a result of pressure differentials between the felt chamber 52 and the external environment. A second vent 60 is formed within the lid 48 to allow direct fluid communication between the free ink chamber 50 and the external environment. This vent 60, in this exemplary embodiment, is also useful for acting as a fill or refill port where ink can be directed into the free ink chamber 50. A fill ball 61 is received within the vent 60 and is operative to plug the vent 60 subsequent to a filling or refilling operation.

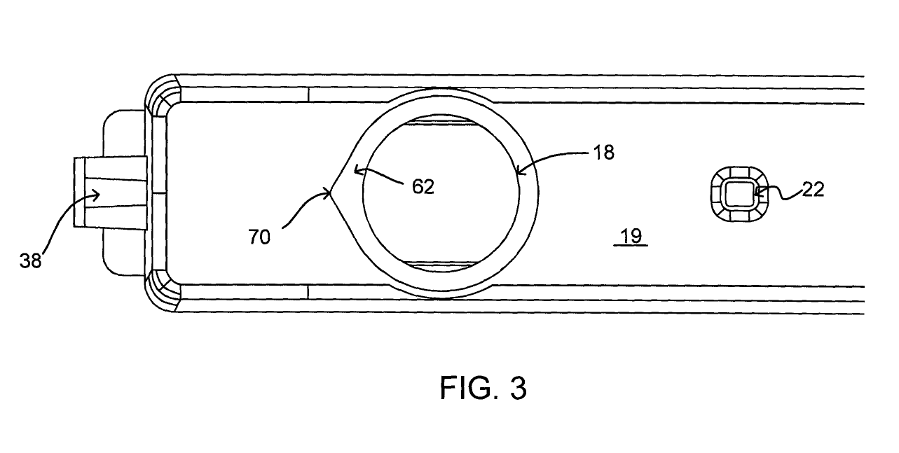

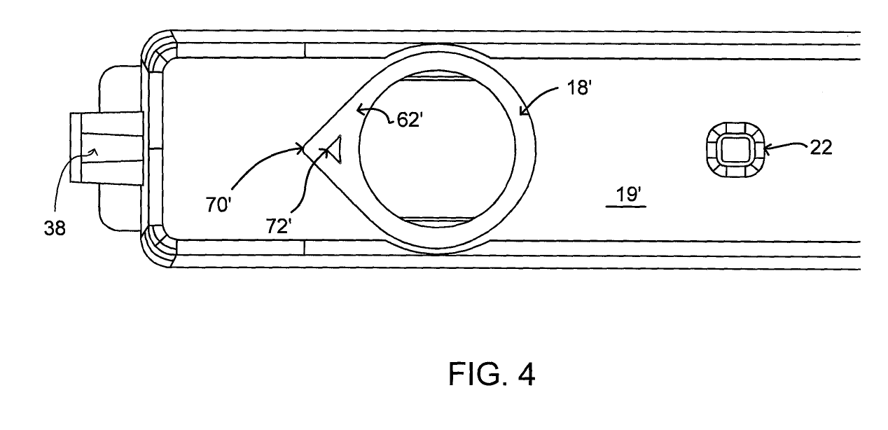

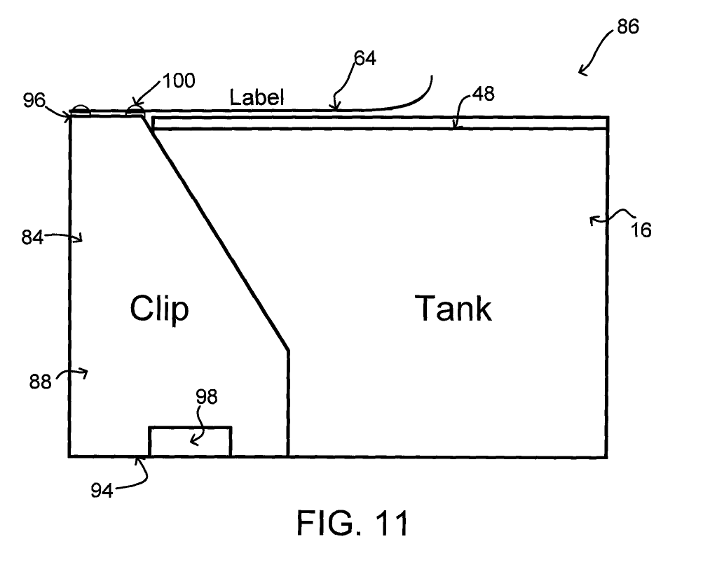

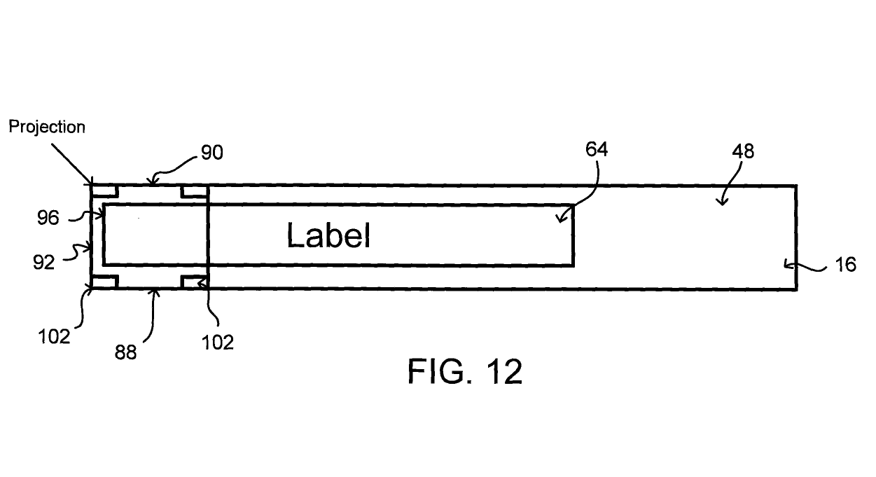

Referencing FIGS. 3, 4, 11 and 12, prior to installation of the ink cartridge, a sealing film 62 (see FIGS. 3 and 4) is bonded over the snout 18, while a sealing label 64 (see FIGS. 11 and 12) is bonded over the vents 58, 60, to inhibit ink from exiting the ink cartridge 16 prematurely; i.e., before the end consumer is prepared to install the ink cartridge 16. Prior to installation of the ink cartridge 16, both the sealing film 62 and sealing label 64 are removed to expose the vents 58, 60 and the snout 18.

Referring specifically to FIGS. 3 and 4, an exemplary snout 18 extends downwardly from the floor 19 of the ink cartridge 16 and includes a constant interior diameter, with a varying exterior circumferential shape that increases in diameter and deforms to define an overall teardrop-shaped cross section having an apex 70. The first exemplary snout apex 70 shown in FIG. 3 tapers outward approximately 120 degrees, while the second exemplary snout apex 70′ shown in FIG. 4 tapers outward approximately 90 degrees. The second exemplary snout 18′ also includes a longitudinal pocket 72′ formed by an opening extending in an axial direction of the snout 18′ until reaching the floor 19′. As discussed above, the snout 18, 18′ is closed off by a sealing film 62, 62′ that is removed prior to installing the ink cartridge 16 on the printhead body 10. The apex 70, 70′ is operative to concentrate the force applied to the sealing film 62, 62′, originating on the side of the apex 70, 70′, when a user attempts to peel the film from the snout 18, 18′. This allows the user to more easily begin the act of peeling the film from the snout; and once the film peel has begun, the remaining film is much more easily removed. Concentrating the force at the apex 70, 70′ reduces the force necessary to peel the film 62, 62′ from the snout 18, 18′ and also provides a more predictable peel. The apex 70, 70′ can be sharply pointed or can be slightly or predominantly rounded. As the angle of the apex 70, 70′ increases toward 180 degrees, forces are dissipated, whereas forces are concentrated as the angle of the apex approaches zero degrees. In the exemplary embodiments of the instant invention, the apexes 70, 70′ are intended to be between 25 and 160 degrees, with angles most often being between 60 and 120 degrees.

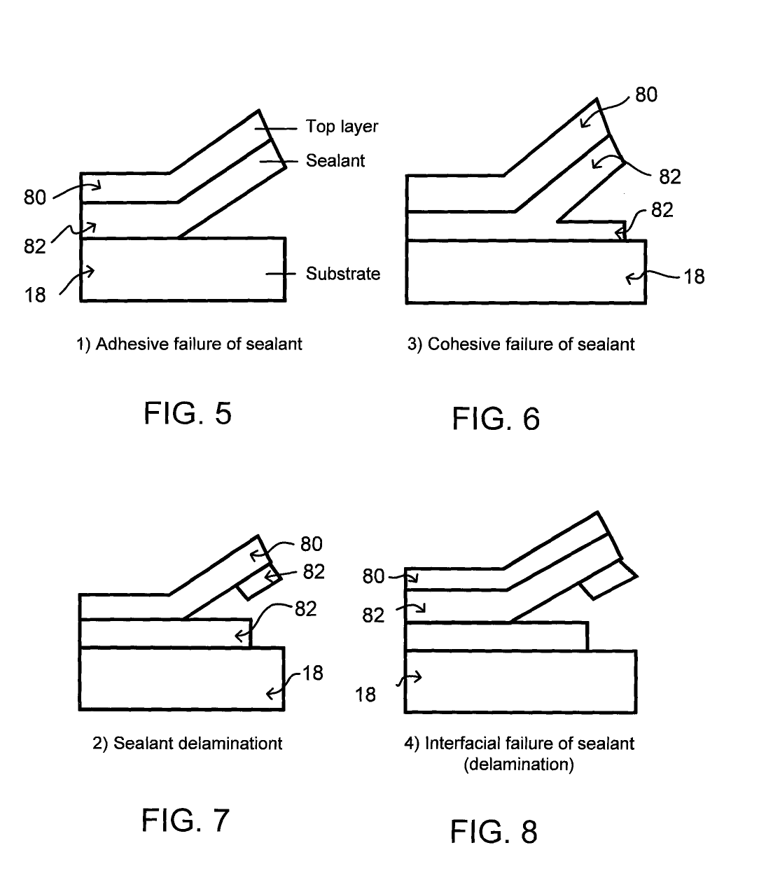

Referring to FIGS. 5-8, an exemplary sealing film 62 for use with the exemplary embodiments of the invention comprises two plies. A first primary top ply 80 of the film comprises a polymer such as, without limitation, polypropylene, polyethylene, nylon, polyvinylchroide, polyester, polyamide, polystyrene, polyethylene terephthalate, paper, etc, while a second interface ply 82 of the film comprises an adhesive such as, without limitation, polyolefins copolymers, ethylene vinyl acetate copolymers, modified acrylics, modified elastomers, etc. Exemplary processes for mounting the sealing film 62 to the mouth of the snout 18 includes simple adhesive sealing and thermal sealing. Simple adhesive sealing relies upon an adhesive to bond one substrate to another, preferably forming a laminate. Thermal sealing, on the other hand, may or may not use an adhesive, but also utilizes changes in state of the adhesive and/or substrate to form bonds mounting one substrate to another, preferably forming a laminate. Depending upon the materials selected to comprise the first and second plies 80, 82, as well as the method of applying the sealing film 62 to a substrate, such as the mouth of the snout 18 of an inkjet ink cartridge 16, at least four different failures modes are available when the two-ply film 62 is peeled from the substrate.

The first failure mode, shown in FIG. 5, is an adhesive failure. In this failure mode, the adhesive 82 adheres to the first ply 80, but the adhesive 82 does not adhere to the mouth of the snout 18, so that as the film 62 is peeled away from the mouth, the vast majority of the adhesive 82 remains bonded to the first ply 80. The second failure mode, shown in FIG. 6, is a cohesive failure. This failure mode is a failure of the adhesive 82 to bond to itself, more so than to the mouth of the snout 18 or the first ply 80. The third failure mode comprises an adhesive delamination and is shown in FIG. 7. This failure mode is also a failure of the adhesive to bond systematically to the mouth of the snout 18 and to the top ply 80. When the film 62 is peeled, some of the adhesive 82 remains bonded to the mouth of the snout 18 and no longer to the first ply 80, whereas other sections of the adhesive 82 delaminate with respect to the mouth of the snout 18 and continue to be bonded to the first ply 80. As a result of this failure, the resulting surface is rough and uneven. The final type of failure is interfacial failure, as shown in FIG. 8, and exists when the heat sealable film comprises of more than 2 layers.

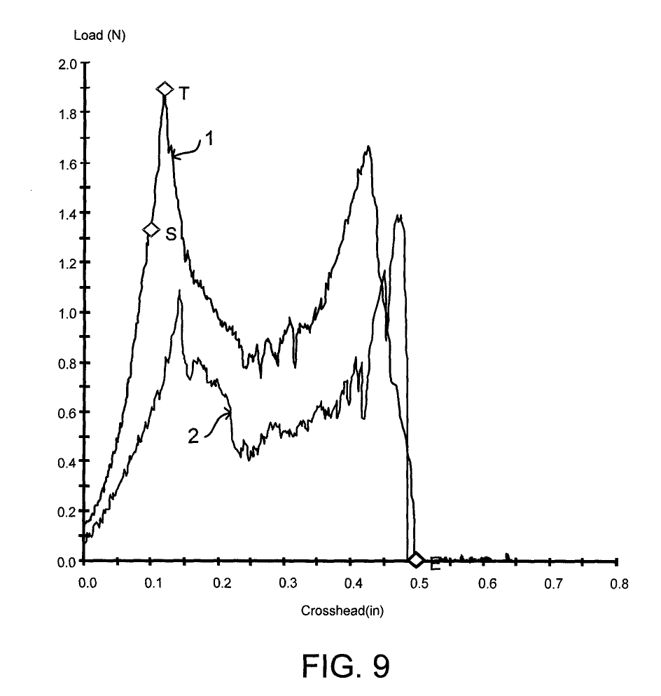

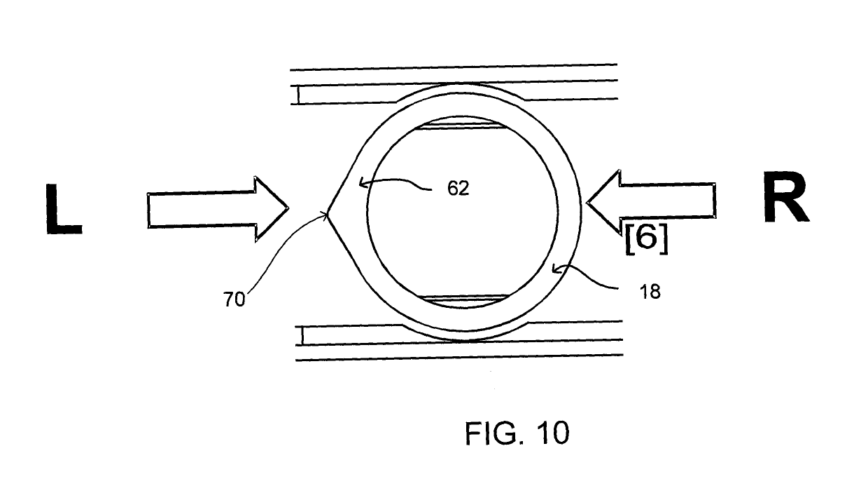

Referring to FIGS. 9 and 10, certain exemplary embodiments of the instant invention promote an adhesive failure mode such as that shown in FIG. 5 to an advantage. Promoting this adhesive failure mode provides a certain predictability in the resulting surface of the snout 18 subsequent to peeling of the film 62, as well as a reduction in the force applied to remove the film 62. FIG. 9 is a composite plot showing the forces required to peel an exemplary film 62 from opposing sides of the mouth of the snout 18 shown in FIG. 10, where the film exhibits an adhesive failure mode. Plot 1 includes data points taken as the film 62 was peeled from the snout 18 in a right R to left L direction (starting opposite the apex 70), whereas Plot 2 includes data points taken as the film 62 was peeled from the snout 18 in a left L to right R direction (starting on the apex 70 side). The composite plot clearly confirms that the forces required to peel the film 62 from the apex 70 side remain lower than forces applied to peel the film 62 in the opposite direction across almost the entire peel. It should be noted, however, that the present invention is not limited to films 62 adapted to promote adhesive failure, particularly in instances where a gasket is used to compensate for uneven surfaces exhibited as a result of cohesive failures, adhesive delamination failures, and interfacial failures, such as those shown in FIGS. 6-8. It will also be appreciated by those of ordinary skill that the film 62 may include a pull tab extending radially from the apex side of the film to allow for easy gripping by the user and to promote pulling of the film from the apex side of the film.

Referring to FIGS. 11-17, the exemplary inkjet ink cartridge 16 can be mounted to a shipping clip 84 to comprise a shipping unit 86 for retail packaging and intermediate shipping. The shipping clip 84 includes matching trapezoidal side walls 88, 90 separated by a front wall 92, a bottom wall 94, and a top wall 96. An interior space within the shipping clip 84 defined by the aforementioned walls receives a portion the ink cartridge 16 therein, so that the snout 18 of the ink cartridge 16 is received within a hole or pocket 98 through the bottom wall 94. The sealing film 62 is mounted to the snout 18 of the ink cartridge 16, as well as to the bottom wall 94 of the clip 84 over the hole 98. In addition, the sealing label 64 is mounted to the top wall 96 of the clip 84 and to the lid 48 of the ink cartridge 16 using an adhesive, while four polymer mounds 100 on the top wall 96 sandwich the label 64 and permanently mount one end of the label 64 to the top wall 96.

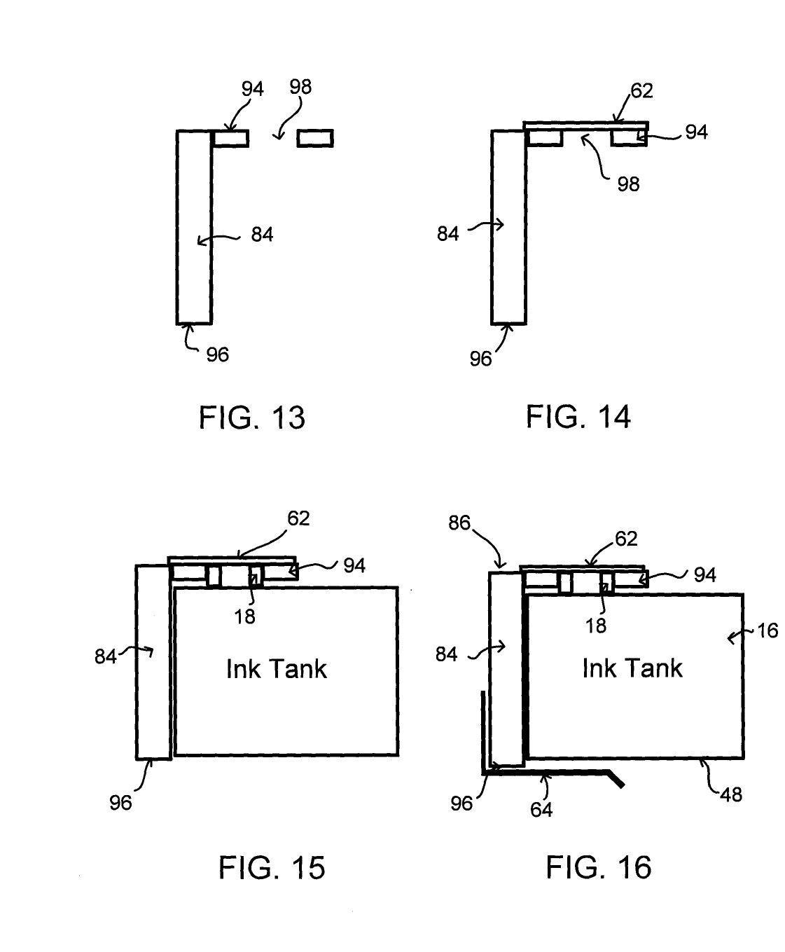

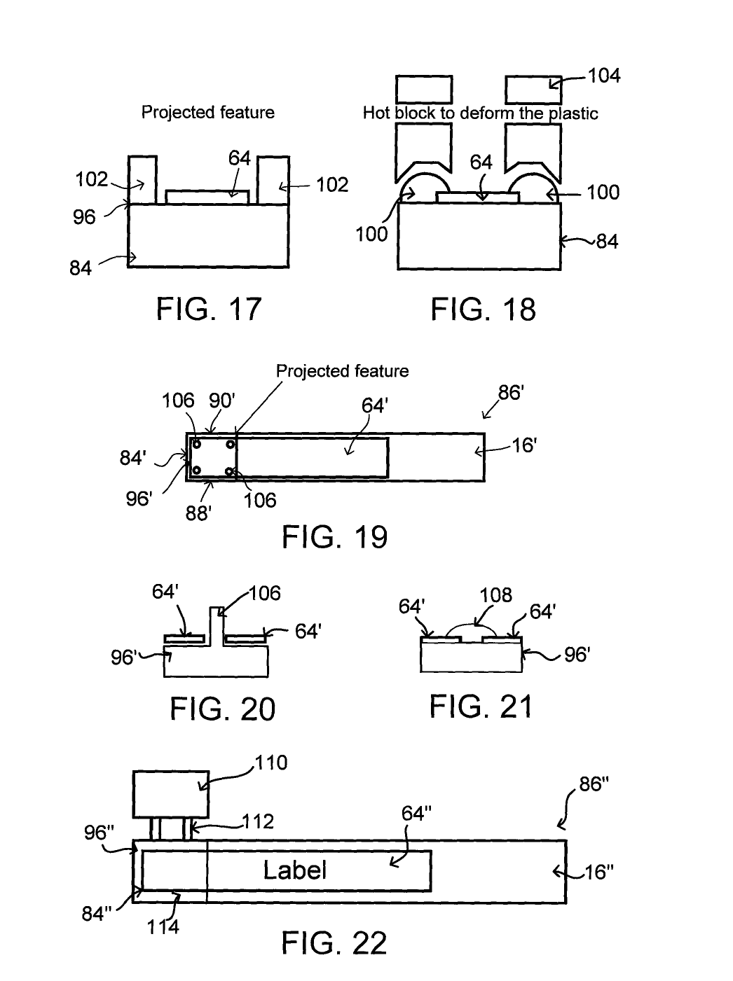

Referring to FIGS. 13-17, fabrication of the exemplary shipping unit 86 includes separately fabricating the shipping clip 84 and the ink cartridge 16. Subsequent to the fabrication of these components 16, 84, the sealing film 62 is mounted to the underside of the bottom wall 94 to form a strong bond around the pocket 98 (see FIG. 14). The ink cartridge 16 is thereafter moved into position with respect to the clip 84 by inserting the snout 18 through the pocket 98, thereby having the exposed end of the snout 18 contacting the film 62. A heat sealing operation is carried out to form a seal between the film 62 and the snout 18 to effectively seal off the opening of the snout. The ink cartridge 16 may then be filled with ink through a fill port (not shown in FIGS. 13-17, see FIG. 1), followed by plugging the vent with the fill ball 61 so that the felt chamber is substantially occupied by a backpressure medium saturated in liquid ink, while the free ink chamber is substantially occupied by liquid ink. The label 64 is subsequently applied with an adhesive to the top wall 96 and to the top of the lid 48, thereby covering and sealing each of the vents, while concurrently straddling the four upstanding posts 102 extending from the top wall 96 (see FIG. 17).

Referencing FIG. 18, a contoured hot block 104 is brought into contact with the upstanding polymer posts 102, thereby melting the polymer posts. The resultant molten polymer is directed by the contour of the hot block 104 to flow over the label 64 and form mounds 100, where the mounds encase a portion of the label 64 to lock one end of the label in place. The hot block 104 is removed from contact with the molten polymer after the mounds 100 have encased the label 64, thereby allowing the molten polymer to cool and solidify in order to permanently bond the label 64 to the clip 84.

Referring to FIGS. 19-21, a first alternate exemplary embodiment of a shipping unit 86′ utilizes an alternate exemplary structure and process for mounting the label 64′ to the top wall 96′ of the clip 84′. In this exemplary process, the label 64′ is precut to include openings that receive upstanding polymer posts 106 extending from the top wall 96′. After the label 64′ is oriented with respect to the top wall 96′ so that the posts 106 extend through the openings of the label 64′, a contoured hot block (not shown) is brought into contact with the polymer posts 106 to liquefy the polymer material. Continued downward pressure upon the polymer posts 106 directs molten polymer over and under the label 64′, as well as filling in the openings through the label 64′, thereby encasing one end of the label in polymer mounds 108 and permanently mounting the label 64′ to the clip 84′.

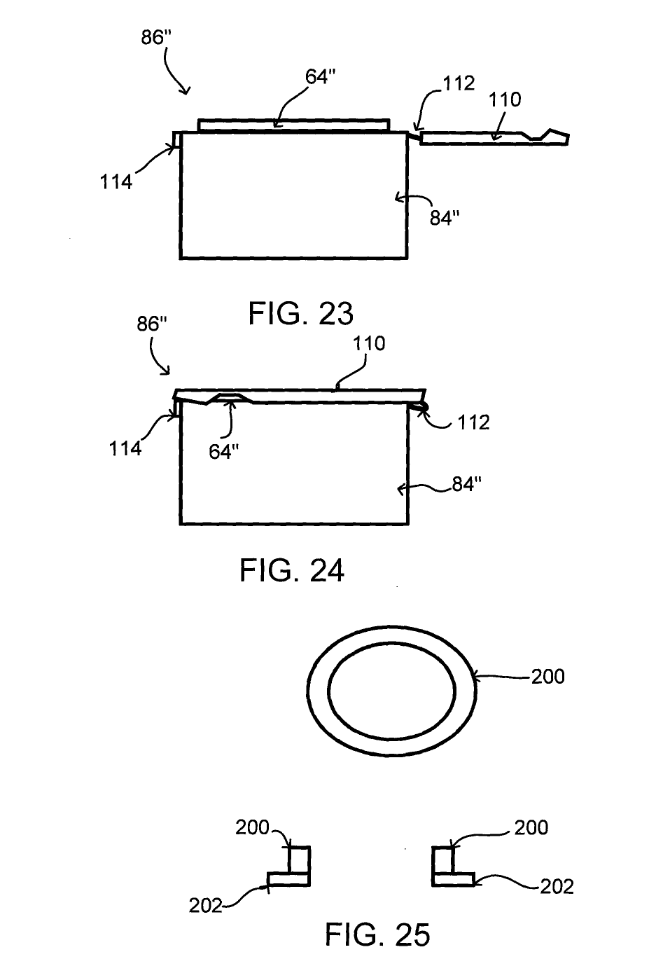

Referring to FIGS. 22-24, a second alternate exemplary embodiment of a shipping unit 86″ utilizes an alternate exemplary clip 84″ that includes a repositionable polymer flap 110 by way of a living hinge 112. The repositionable flap 110 engages a snap feature 114 mounted to the opposing side of the clip 84″. In order to mount the label 64″ to the top wall 96″, the label 64″ is oriented to overlay the top wall 96″ and cover the two vents (not shown) of the ink cartridge 16″. The flap 110 is then repositioned to compress and sandwich the label 64″ between the flap 110 and the top wall 96″, where the orientation of the flap 110 is secured in place by locking engagement with the snap feature 114. This locking engagement effectively mounts the label 64″ to the clip 84″, however, it is also within the scope of the invention to utilize a hot block after the flap 110 is in locking engagement with the snap feature 114 in order to liquefy at least a portion of the polymer flap to permanently mount the flap 110 and the label 64″ to the top wall 96″.

In each of the aforementioned exemplary shipping units 86, 86′, 86″, the adhesive label 64, 64′, 64″ and the film 62 are removed from the ink cartridge 16 prior to installation by a customer. In exemplary form, the adhesive label 64, 64′, 64″ is initially peeled at the end opposite the top wall 96 of the shipping units 86, 86′, 86″ and continued until the adhesive label 64, 64′, 64″ is no longer mounted to the ink cartridge 16. At this point, the ink cartridge 16 remains mounted to the shipping clip 84, 84′, 84″ by way of the film 62. To remove the ink cartridge 16, one pivots the front of the ink cartridge 16 nearest the clip 84, 84′, 84″ in a clockwise direction and concurrently pivots the clip in a counterclockwise direction to effectively peel the film 62 from the snout 18, but retaining the bond between the film and clip. The pivoting action of the cartridge 16 with respect to the clip 84, 84′, 84″ concentrates the force on the apex 70 of the mouth of the snout 18 as the cartridge 16 is removed from the clip. After the initial delamination occurs between the snout 18 and the film 62, the force required to continue the delamination decreases until the very last film is remains mounted to the snout 18, at which point the force required to discontinue this bond actually increases as evidenced by FIG. 9, Plot 2.

The foregoing exemplary embodiments of the invention have utilized a snout 18 with a non-circular cross section at the mouth that preferably includes an apex 70 to coincide with an origination point for delaminating the film 62 from the mouth of the snout 18. However, it has been found by the inventors of the instant invention that other techniques may be utilized to concentrate and thereby decrease the overall force required to remove a film from a snout mouth or other substrate without deviating from a cylindrical snout.

Referring to FIG. 25, an exemplary ink tank incorporates a cylindrical snout 200, as opposed to the teardrop shaped snout 18 of the aforementioned exemplary embodiments. Consistent with the aforementioned exemplary embodiments, the snout 200 extends from the floor 202 of the ink tank and defines a cylindrical conduit providing communication to the interior of the ink tank.

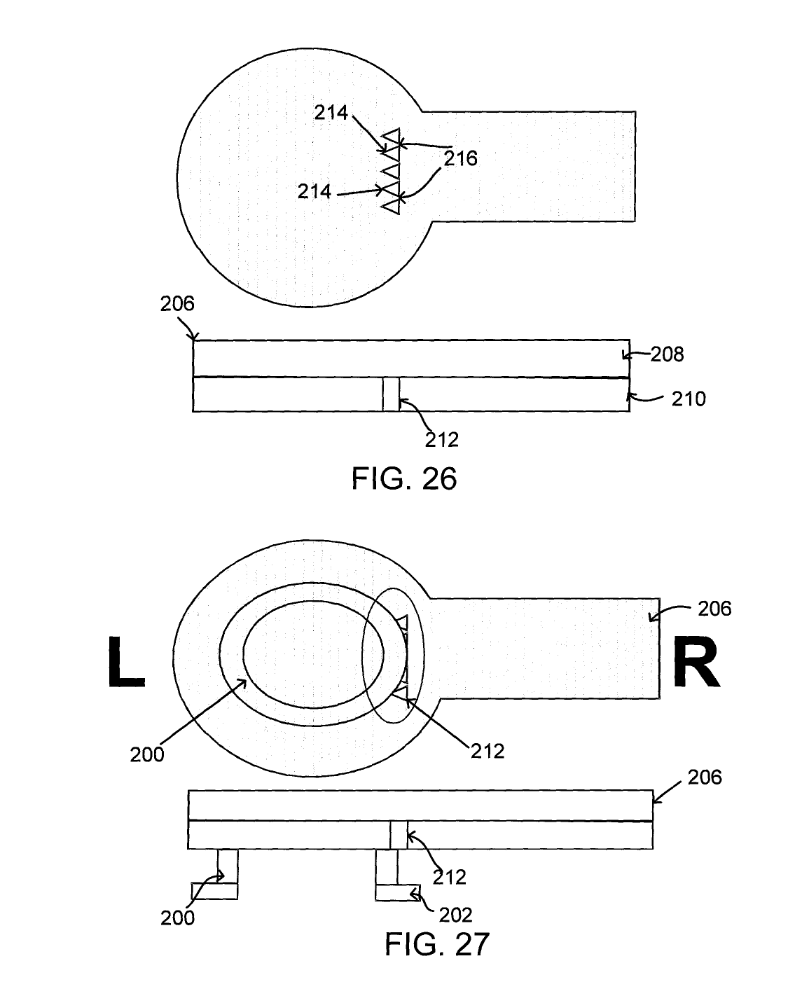

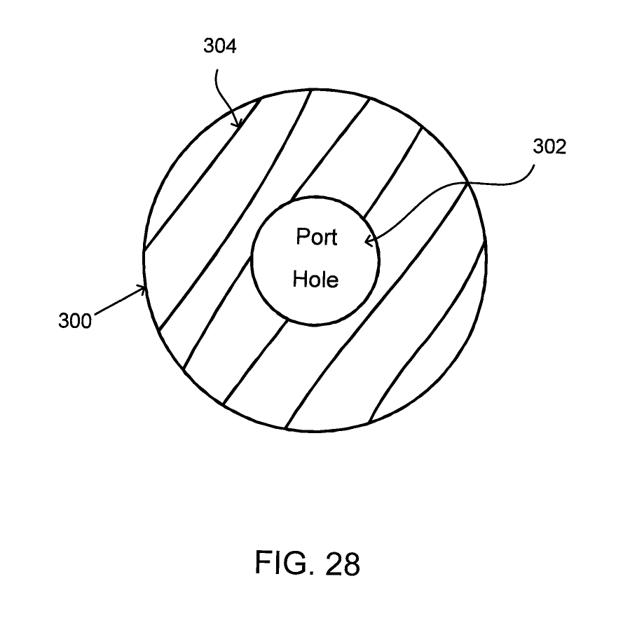

Referencing FIGS. 26 and 27, a two-ply film 206 is bonded to the mouth of the snout 200, where the film 206 includes a polymer layer 208 and an adhesive layer 210. A series of triangular perforations 212 are formed within the adhesive layer 210. These perforations 212 perform a similar function to the apexes 70, 70′ of the aforementioned exemplary embodiments by concentrating the forces applied to the film 206 as a result of peeling the film 206 from right R to left L. In this manner the perforations 212 are preferably aligned over the mouth of the snout 200 prior to sealing the film 206 to the snout 200.

A fluidic seal results from bonding the film 206 circumferentially with respect to the exposed mouth of the snout 200. Exemplary techniques for sealing the film 206 to the snout 200 include, without limitation, adhesive sealing, laser welding, ultrasonic welding, vibrational welding, heat staking, and induction welding (foil seal). However, the fluidic seal is broken prior to installation of the ink tank.

The film 206 is peeled away from the snout 200 from right R to left L over the snout in order to break the fluidic seal. As discussed above, the triangular perforations 212 in the adhesive layer 210 operate to concentrate the forces of the peel at a leading edge of the snout 200, thereby reducing the peel force required to initiate the peel. More specifically, triangular sections 214 are formed between the triangular perforations 212, where the triangular sections include leading or pointed edges 216 that concentrate the forces of the peel as the film 206 is peeled from right R to left L. After the film 206 is peeled away from the snout 200, no appreciable film remains on the snout (see FIG. 25).

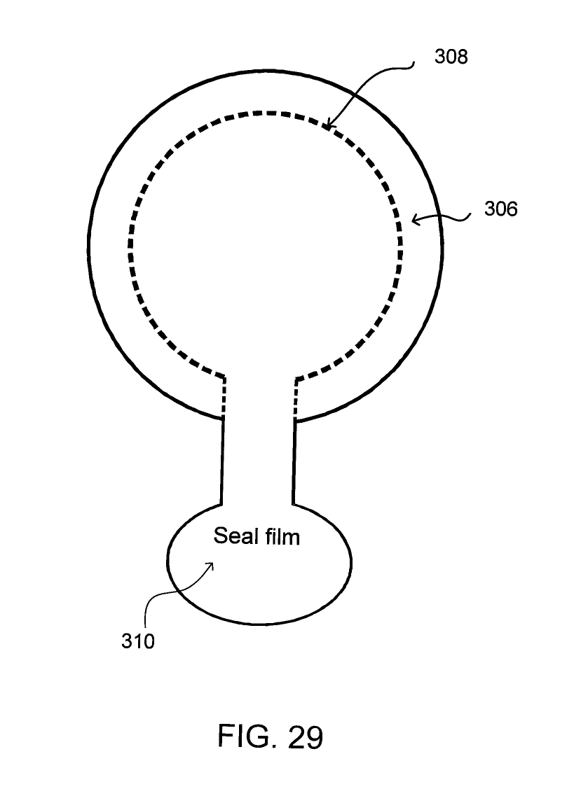

Referring to FIGS. 28-30, a second exemplary circular snout 300 includes a circular opening 302 bounded by a circular exposed mouth surface 304. The seal film 306 may be single or multiple ply, but for purposes of explanation will comprise a dual ply structure. The first ply comprises a polymer layer, while the second layer adjacent to the mouth surface 304 of the snout 300 comprises an adhesive layer. Both of the layers include a circular perforation 308 that is concentric with the opening 302. After the circular perforation has been orientated so that it is concentric with respect to the opening 302 and overlaps the mouth surface 304, the film 306 is mounted to the snout 300. Exemplary techniques for mounting the film 306 to the snout 300 include, without limitation, adhesive sealing, laser welding, ultrasonic welding, vibrational welding, heat staking, and induction welding (for foil seal). However, as with the foregoing exemplary embodiments, the fluidic seal must be discontinued prior to installation of the ink tank.

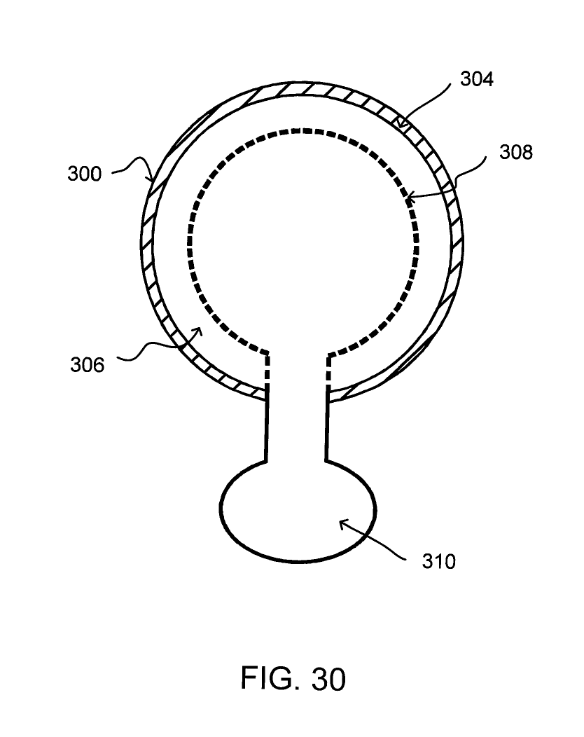

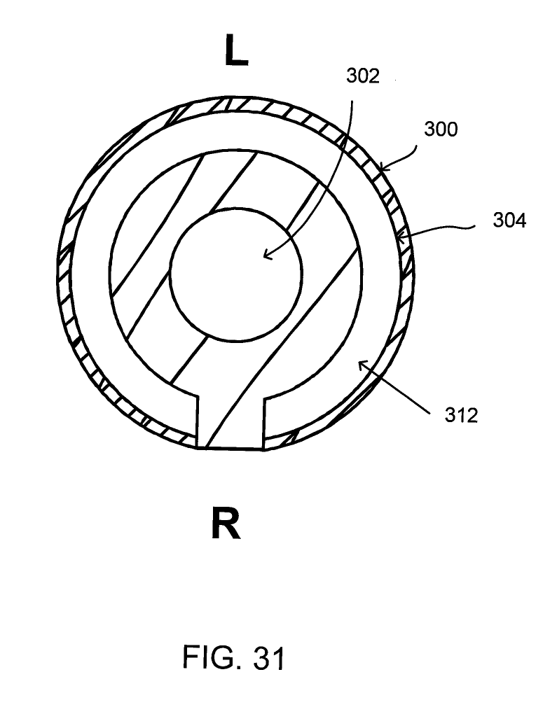

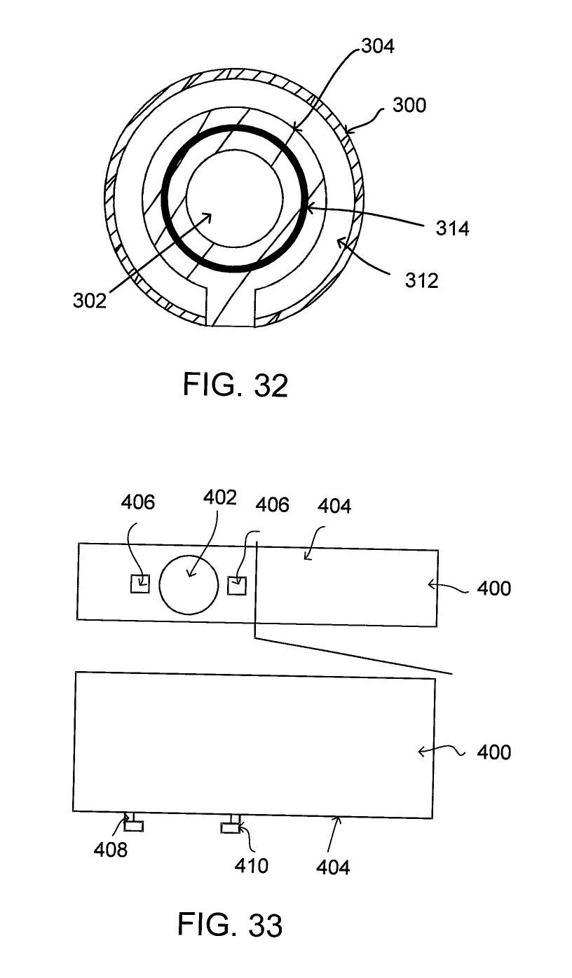

Referring to FIGS. 30-32, the film 306 includes a gripping tab 310 that is grasped and peeled toward the opening 302 of the snout 300 from right R to left L in order to discontinue the fluidic seal. Circular perforations 308 in the film 306 operate to concentrate the forces of the peel at an inset point along the mouth surface 304, thereby delaminating the film 306 from itself, as well as that portion of the film 306 covering the opening 302. However, a ring of film 312 outset from the perforations 308 remains bonded to the mouth surface 304 (see FIG. 31). This remaining ring 312 is not problematic because a gasket 314 or other device is utilized to ensure a fluid tight seal between the snout 300 and printhead body interface (not shown).

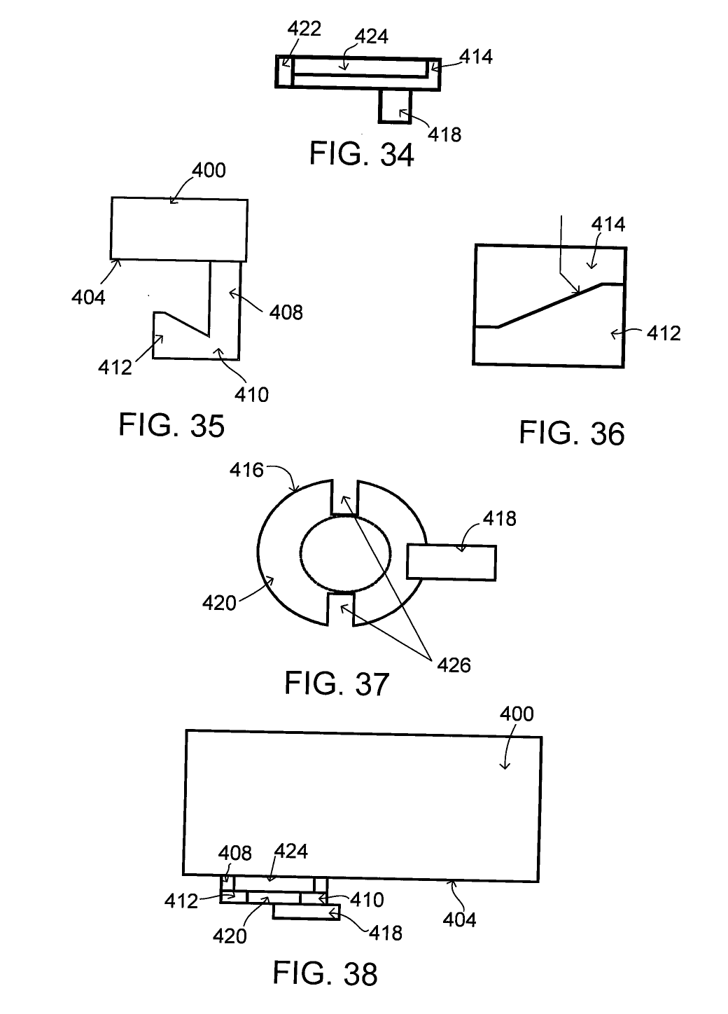

Referencing FIGS. 33 and 34, a further exemplary ink cartridge or tank 400 includes an outlet orifice 402 that is substantially flush with the underside 404 of the tank 400. The outlet orifice 402 is circular in cross-section and includes two or more adjacent attachment arms 406 extending from the underside 404 of the tank 400 that are positioned circumferentially equidistant from one another. Each arm 406 includes a vertical leg 408 integral with a horizontal leg 410 comprising a trapezoidal ramp 412. Each trapezoidal ramp 412 is adapted to interface with a corresponding trapezoidal ramp 414 of a removable ink cap 416 to mount the cap to the tank 400 to seal off the outlet orifice 402.

Referring to FIGS. 35 and 36, the removable ink cap 416 includes a handle 418 extending from the underside of a circular platform 420. Two spiral ramps 414 and an adjacent detent 422 extend from the circular platform 420, opposite the handle 418, which are positioned circumferentially equidistant from one another in order to releasable engage the trapezoidal ramp 412 of the ink tank attachment arms 406. A circular elastomeric insert 424 is seated between the two spiral ramps 414 and is adapted to seal off the outlet orifice 402 when the cap 416 is mounted to the tank 400. Two rectangular cutouts 426 through the platform 420 allow the vertical egress of the horizontal legs 410 therethrough as the cap 416 is installed and removed.

To install the cap 416, the cutouts 426 are aligned with the horizontal legs 410 and the cap is moved toward the underside 404 of the tank 400. Continued movement of the cap 416 toward the tank 400 results in the horizontal legs 410 passing through the cutouts 426 and the circular insert 424 being directly against the underside 404 of the tank, thereby sealing the outlet orifice 402. The cap 416, with the circular insert 424 in sealing engagement with the outlet orifice 402, is rotated in a clockwise direction by clockwise repositioning of the handle 418 so that each spiral ramp 414 engages a corresponding trapezoidal ramp 414. Continued rotation of the cap 416 in the clockwise direction compresses the spiral ramps 414 against the trapezoidal ramps 412, thereby compressing the circular insert 424 against the underside 404 of the tank 400 to seal off the outlet orifice 402. Further rotation of the cap 416 in the clockwise direction causes each detent 422 to pass beyond a corresponding trapezoidal ramp 412, thereby locking the cap in place (see FIG. 38). In order to remove the cap 416 from the tank 400, the cap 416 is rotated in the counterclockwise direction to allow the detent 422 to pass over the trapezoidal ramp 412, followed by continued counterclockwise rotation until the cutouts 426 are aligned with the horizontal legs 410 and the cap. Thereafter, the cap 416 is moved vertically away from the tank 400 to completely disengage the tank 400 in order to facilitate installation of the tank to a printing apparatus (not shown).

While many of the aforementioned exemplary embodiments have incorporated perforations to concentrate forces associated with removing one substrate from another substrate or removing a portion of one substrate from the remainder of the substrate, it is to be understood that other features may be used in lieu of or in addition to perforations. For example, substrates may be manufactured to include embedded fractures/notches or other features that provide predetermined separation of one substrate from another substrate or from one portion of a substrate from the remainder of the substrate. Examples of fractures include cracks or spacing within a substrate along which the cracks or spacing facilitate separation of one substrate from another substrate or from one portion of a substrate from the remainder of the substrate.

Following from the above description and invention summaries, it should be apparent to those of ordinary skill in the art that, while the methods and apparatuses herein described constitute exemplary embodiments of the present invention, the invention contained herein is not limited to this precise embodiment and that changes may be made to such embodiments without departing from the scope of the invention as defined by the claims. Additionally, it is to be understood that the invention is defined by the claims and it is not intended that any limitations or elements describing the exemplary embodiments set forth herein are to be incorporated into the interpretation of any claim element unless such limitation or element is explicitly stated. Likewise, it is to be understood that it is not necessary to meet any or all of the identified advantages or objects of the invention disclosed herein in order to fall within the scope of any claims, since the invention is defined by the claims and since inherent and/or unforeseen advantages of the present invention may exist even though they may not have been explicitly discussed herein.

1. An ink tank, comprising:
a housing;
an ink chamber defined within the housing having an initial or refillable volume of ink;
a snout defined by an exterior of the housing having a shape configured to mate with a receiving port in fluid communication with inkjet nozzles in an imaging device, the snout having an opening in fluid communication with the ink in the ink chamber; and
a sealing film covering the opening to substantially prevent the ink from leaking out of the ink chamber, the sealing film having a tear-shaped periphery with an angular apex to concentrate a pulling force on the sealing film upon a user originating pealing the sealing film before fluidly mating the opening of the snout with the receiving port.

2. The ink tank of claim 1, wherein the angular apex ranges from about 25 degrees to about 160 degrees.

3. The ink tank of claim 1, wherein the sealing film includes two plies of material defining the tear-shaped periphery.

4. The ink tank of claim 3, wherein a top of the two plies includes paper or a polymer having polypropylene, polyethylene, nylon, polyvinylchloride, polyester, polyamide, polystyrene or polyethylene terephthalate.

5. The ink tank of claim 3, wherein a bottom of the two plies includes polyolefin copolymers, ethylene vinyl acetate copolymers, modified acrylics, or modified elastomers.

6. The ink tank of claim 3, wherein the two plies are adhesively bonded to one another.

7. The ink tank of claim 1, further including a shipping clip attached to the housing, the sealing film further mounting to the shipping clip.

8. The ink tank of claim 1, wherein the sealing film is heat sealed to the exterior of the housing for said covering the opening of the snout.

9. An ink tank, comprising:
a housing;
an ink chamber defined within the housing having an initial or refillable volume of ink;
a fluid port defined by an exterior of the housing having a shape configured to mate with a receiving port in fluid communication with inkjet nozzles in an imaging device, the fluid port having an opening in fluid communication with the ink in the ink chamber; and
a sealing film covering the opening to substantially prevent the ink from leaking out of the ink chamber, the sealing film having a tear-shaped periphery with an angular apex for a user to originate pealing the sealing film before fluidly mating the opening with the receiving port.

10. An ink tank, comprising:
a housing;
an ink chamber defined within the housing having an initial or refillable volume of ink;
a fluid port defined by an exterior of the housing having a shape configured to mate with a receiving port in fluid communication with inkjet nozzles in an imaging device, the fluid port having an opening in fluid communication with the ink in the ink chamber; and
a sealing film covering the opening to substantially prevent the ink from leaking out of the ink chamber, the sealing film having a peripheral shape sufficiently sized to completely seal the opening and having a plurality of perforations in the sealing film to concentrate a pulling force upon a user originating pealing.

11. The ink tank of claim 10, wherein the perforations include a series of triangular shapes pointed toward the opening.

12. The ink tank of claim 10, wherein the sealing film includes two plies of material.

13. The ink tank of claim 12, wherein a top of the two plies includes paper or a polymer having polypropylene, polyethylene, nylon, polyvinylchloride, polyester, polyamide, polystyrene or polyethylene terephthalate.

14. The ink tank of claim 12, wherein a bottom of the two plies includes polyolefin copolymers, ethylene vinyl acetate copolymers, modified acrylics, or modified elastomers.

15. The ink tank of claim 12, wherein the two plies are adhesively bonded to one another.

16. The ink tank of claim 12, wherein all the perforations exist in a bottom of the two plies.

17. The ink tank of claim 10, wherein the opening has a circular shape and the peripheral shape is circular.

18. The ink tank of claim 10, wherein the sealing film further includes a handle for the user to grasp to said originate pealing.

19. The ink tank of claim 18, wherein each of the perforations has a shape oriented with a point on a side of the perforations on the sealing film opposite the side of the handle.

20. The ink tank of claim 10, wherein the sealing film includes a top polymer ply and a bottom adhesive ply, the perforations in the sealing film having a shape to promote failure in the adhesive ply in lieu of failure in the top polymer ply.
